(19) United States
(12) Patent Application Publication
(10) Pub. No.: US 2022/0398121 A1
(43) Pub. Date: Dec. 15, 2022

(54) DELAY TOLERANT EDGE COMPUTE PROTOCOL

(71) Applicant: Noodle Technology Inc., San Francisco, CA (US)

(72) Inventors: Lucien Jean Baptiste Loiseau, San Francisco, CA (US); Garrett Edward Kinsman, San Francisco, CA (US); Micha Anthenor Benoliel, San Francisco, CA (US); Eliott Quentin Eric Teissonniere, San Francisco, CA (US)

(21) Appl. No.: 17/806,451

(22) Filed: Jun. 10, 2022

Related U.S. Application Data
(60) Provisional application No. 63/209,955, filed on Jun. 11, 2021.

(51) Int. Cl. G06F 9/455; G06F 8/70

(52) U.S. Cl. CPC G06F 9/45558; G06F 8/70; G06F 2009/45595; G06Q 50/01

(57) ABSTRACT

A method for communicating includes transmitting a code to a first device via a first network. The code is configured to execute on a virtual environment associated with the first device. When executed on the virtual environment, the code causes the first device to communicate with a second device via a second network. The first network is based on a first network protocol, and the second network is based on a second network protocol different from the first network protocol.

### CROSS REFERENCE TO RELATED APPLICATIONS

This U.S. patent application claims priority under 35 U.S.C. § 119(e) to U.S. Provisional Application 63/209,955, filed on Jun. 11, 2021. The disclosure of this prior application is considered part of the disclosure of this application and is hereby incorporated by reference in its entirety.

### TECHNICAL FIELD

This disclosure relates to decentralized networking and to a delay tolerant edge compute protocol.

### BACKGROUND

The Internet of Things (IoT)—the network of connected “Smart” devices that communicate seamlessly over the Internet—is expanding into every aspect of human life. Increasingly, IoT devices are being used for healthcare at hospitals, and in medical device and pharmaceutical manufacturing. In cities, IoT devices help track and monitor pollution. IoT devices can also be used by governments, militaries, companies, and individuals for asset tracking and management. Although these applications serve different purposes, they all share one characteristic—a dependence on strong connectivity. Soon, conventional networks will be unable to handle the bandwidth requirements of billions of IoT devices.

The subject matter claimed herein is not limited to implementations that solve any disadvantages or that operate only in environments such as those described above. Rather, this background is only provided to illustrate one example technology area where some implementations described herein may be practiced.

### SUMMARY

One aspect of the disclosure provides a method for communication. The method includes transmitting a code to a first device via a first network. The code is configured to execute on a virtual environment associated with the first device. When executed on the virtual environment, the code causes the first device to communicate with a second device via a second network. The first network is based on a first network protocol and the second network is based on a second network protocol different from the first network protocol.

Implementations of the disclosure may include one or more of the following optional features. In some implementations, the virtual environment is a containerization environment. In some implementations, the virtual environment is a virtualization environment. In some implementations, the code is a containerized program. In some implementations, the code is an instruction capable of executing on a virtual machine.

Optionally, the first network includes a cellular network, and the second network includes a short-range wireless network. In some implementations, the communication includes providing hotspot service to the second device via the second network. In some implementations, the communication includes requesting data from the second device via the second network. The data is generated by an Internet of Things (IoT) device associated with the second device. In some implementations, the communication includes receiving data from the second device via the second network. The data is generated by an Internet of Things (IoT) device associated with the second device.

Another aspect of the disclosure provides a network system for communication. The network system includes data processing hardware and memory hardware in communication with the data processing hardware. The memory hardware stores instructions that when executed on the data processing hardware cause the data processing hardware to perform operations including transmitting a code to a first device via a first network, the code configured to execute on a virtual environment associated with the first device. When executed on the virtual environment, the code causes the first device to communicate with a second device via a second network. The first network is based on a first network protocol and the second network is based on a second network protocol different from the first network protocol.

Implementations of the disclosure may include one or more of the following optional features. In some implementations, the virtual environment is a containerization environment. In some implementations, the virtual environment is a virtualization environment. In some implementations, the code is a containerized program. In some implementations, the code is an instruction capable of executing on a virtual machine.

Optionally, the first network includes a cellular network, and the second network includes a short-range wireless network. In some implementations, the communication includes providing hotspot service to the second device via the second network. In some implementations, the communication includes requesting data from the second device via the second network. The data is generated by an Internet of Things (IoT) device associated with the second device. In some implementations, the communication includes receiving data from the second device via the second network. The data is generated by an Internet of Things (IoT) device associated with the second device.

Another aspect of the disclosure provides a network system for asset tracking. The network system includes data processing hardware and memory hardware in communication with the data processing hardware. The memory hardware stores instructions that when executed on the data processing hardware cause the data processing hardware to perform operations comprising receiving a report of lost or stolen item, adding an identifier of the lost or stolen item to a watch list, receiving a beacon, determining that the received beacon is originated from the lost or stolen items based on the watch list, and when the relay server determined that the received beacon originated from the lost or stolen items on the watch list, notifying, by the relay server, that the lost or the stolen item is found.

Implementations of the disclosure may include one or more of the following optional features. In some implementations, the identifier includes a unique identification assigned to the lost or stolen item, or a geographical location of the lost or stolen item. For example, the unique identification includes at least one of a media access control (MAC) address or universally unique identifier (UUID). In some implementations, the beacon is received from an intermediate device configured with a virtual machine to watch for the beacon transmitted from an endpoint device. In some implementations, the intermediate device includes a first network controller configured to communicate with the endpoint device via a first network; and a second network controller configured to communicate with the relay server via a second network. For example, the first network includes a low-power network, and the second network includes at least one of a cellular network, a Wireless Fidelity (WI-FI) network, or Internet network. In some implementations, the intermediate device includes at least one of a personal computers, a laptop, a smart phone, a netbook, an e-readers, a personal digital assistant (PDA), a cellular phone, a mobile phone, a tablet, a vehicle, a drone, a car, a truck, a wearable device, a router, a television, or a set top box.

In some implementations, the relay server includes a computing device configured to receive the beacon from the intermediate device. In some implementations, the relay server includes a data storage including data related to the received beacon.

Another aspect of the disclosure provides a method for asset tracking. The method includes system includes receiving a report of lost or stolen item, adding an identifier of the lost or stolen item to a watch list, receiving a beacon, determining that the received beacon is originated from the lost or stolen items based on the watch list, and when the relay server determined that the received beacon originated from the lost or stolen items on the watch list, notifying, by the relay server, that the lost or the stolen item is found.

Implementations of the disclosure may include one or more of the following optional features. In some implementations, the identifier includes a unique identification assigned to the lost or stolen item, or a geographical location of the lost or stolen item. For example, the unique identification includes at least one of a media access control (MAC) address or universally unique identifier (UUID). In some implementations, the beacon is received from an intermediate device configured with a virtual machine to watch for the beacon transmitted from an endpoint device. In some implementations, the intermediate device includes a first network controller configured to communicate with the endpoint device via a first network; and a second network controller configured to communicate with the relay server via a second network. For example, the first network includes a low-power network, and the second network includes at least one of a cellular network, a Wireless Fidelity (WI-FI) network, or Internet network. In some implementations, the intermediate device includes at least one of a personal computers, a laptop, a smart phone, a netbook, an e-readers, a personal digital assistant (PDA), a cellular phone, a mobile phone, a tablet, a vehicle, a drone, a car, a truck, a wearable device, a router, a television, or a set top box.

In some implementations, the relay server includes a computing device configured to receive the beacon from the intermediate device. In some implementations, the relay server includes a data storage including data related to the received beacon.

### DESCRIPTION OF DRAWINGS

FIG. 1 is a schematic view of a network architecture including one or more endpoint devices, one or more intermediate devices, one or more relay servers, and one or more endpoint manager servers in accordance with some implementations of the present disclosure.

FIGS. 2a-e are schematic views illustrating a method of delay tolerance communication using a network architecture in accordance with some implementations of the present disclosure.

FIG. 3 is a schematic view of virtual environment of an edge node device in accordance with some implementations of the present disclosure.

FIG. 4 is a flowchart of an example arrangement of operations for a method of delay tolerance communication.

FIG. 5 is a schematic view illustrating a machine in the example form of a computing device.

### DETAILED DESCRIPTION

The Internet of Things (IoT) is expanding into every aspect of human life. With over 75 Billion IoT devices expected to be deployed by 2025, a more efficient new network infrastructure is needed to bring these devices online and connect them to each other.

Many connectivity solutions exist for IoT devices. Unfortunately, all suffer problems of limited bandwidth, decreased connectivity, high power consumption, and/or high cost. For example, cellular connections may consume significant power in a device and may also be expensive. Low power solutions, such as a Low-Power Wide-Area Network (LPWAN) may consume less power than cellular connections. LPWANs, however, may be constrained by limited bandwidth and may not be able to transmit enough data to fully serve the needs of distributed networks. Conventional systems may not consume a relatively low amount of power while still providing high bandwidth.

Specifically, to connect a small device to the Internet today, existing solutions include: (a) using an existing wireless network, for example, by incorporating a cellular module with a Subscriber Identification Module (SIM) card or software SIM (e.g., eSIM) into the device to give it a cellular connection; (b) building a new alternative wireless network by incorporating a custom radio chipset and building fixed infrastructure to support this network; and (c) using long range network technology (e.g., network technology from LoRa Alliance). LoRa uses a complex “star-of-stars” topology of gateways and bridges between IoT devices and a “central network server” on the industrial, scientific and medical (ISM) spectrum band.

Each of these approaches have significant drawbacks. For example, each of these approaches require a significant amount of power which often is a major contributor to battery drain in mobile devices. Further, approach (a) requires expensive cellular modules and, in addition, a monthly fee for wireless cellular service for both, service subscription and data to a wireless carrier. Approaches (b) and (c) are also expensive, because they require building new, fixed infrastructure, and often require purchasing a (separate) chipset for radio transmission in addition to the popular Bluetooth® chipsets. The longer the transmission range, the greater the power requirement, so each of these approaches require significant power. Similarly, cellular devices and Global Positioning System (GPS) enabled devices require high power to communicate with a cell tower or satellites because of longer distances.

Aspects of the present disclosure address these and other problems with conventional networking by providing a protocol for data exchange in a decentralized network. In some aspects, the present disclosure provides systems and methods to turn a crowd-source infrastructure into an asynchronous programmable network that can tap into the resources available on each edge node. In some aspects, a decentralized network may connect numerous devices using low-power while providing higher connectivity and/or bandwidth. An implementation includes a crowd-source based method for sending or transmitting data from an IoT device to a server (e.g., cloud server) that does not rely on a fixed infrastructure. Another implementation includes a crowd-source method for a server (e.g., cloud server) to send data to and receive data from an IoT device that does not rely on a fixed infrastructure. A further implementation includes a method for routing data in beacon signals from multiple services on multiple IoT devices to the appropriate device manufacturer servers (e.g., cloud server). Yet another implementation includes a method to reduce energy consumption on mobile devices used to collect or exchange data with remote IoT devices. Yet another implementation includes a method to trigger or execute various interactions with a device. Yet another implementation includes providing a mechanism to permit anyone to write a program to interact, based on any condition, with any device using a delay tolerant decentralized network.

In one aspect, the present disclosure describes systems and techniques to improve upon existing technologies by obviating the need for separate, fixed infrastructure by using crowd-sourcing techniques. Some aspects provide a methodology for IoT device-to-server communication that has a low power consumption profile and does not require massive fixed hardware infrastructure. Other benefits of the present disclosure is in its ability to lower the cost of Internet access and to create a platform for new innovations in the field of IoT, including providing an ability for anyone to create and publish programs for IoT devices and to set conditions by which the programs may execute.

The present disclosure may be useful to virtually every field that uses network-based communications. Example parties that may benefit from this disclosure include, but are not limited to, smartphone manufacturers, bike and ride sharing companies, outdoor advertisers, environmental analytics companies, asset tracking entities, distributed computing companies, etc. Example applications may include use for pollution tracking, asset tracking, finding lost devices, industrial predictive maintenance, distributed network routing, distributed computing, etc. Further, aspects of the present disclosure may not rely on connectivity using SIM or LPWAN modems, which enables devices to be smaller and more efficient.

For example, in location tracking of devices and assets scenarios, most low cost tracking device makers rely on application users to locate devices, and do not have sufficient application density to provide global coverage. Adding a cellular module and a GPS module is expensive and power hungry. Aspects of the present disclosure may provide a solution that does not require endpoint devices to include cellular or GPS modules which interoperates globally, and lowers costs.

Some aspects may also be used for firmware updates, updating date and time of devices, creating a wearable device network, data IP connectivity, measuring population density (such as by detecting the number of Bluetooth® devices in a given location), checking the presence of a specific device for insurance companies, detecting trends of sales of a specific device for market analytics companies, hedge funds and private equity companies, etc.

Moreover, delay tolerant use cases, such as location updates and environmental/health data, may also benefit from the present disclosure. For example, many use cases do not require immediate cloud or Internet connectivity. In this context, the present disclosure leverages smartphones' various networking capabilities, such as Bluetooth® connectivity, and their Wi-Fi offloading capabilities, to offer a significantly enhanced bandwidth compared to LPWANs.

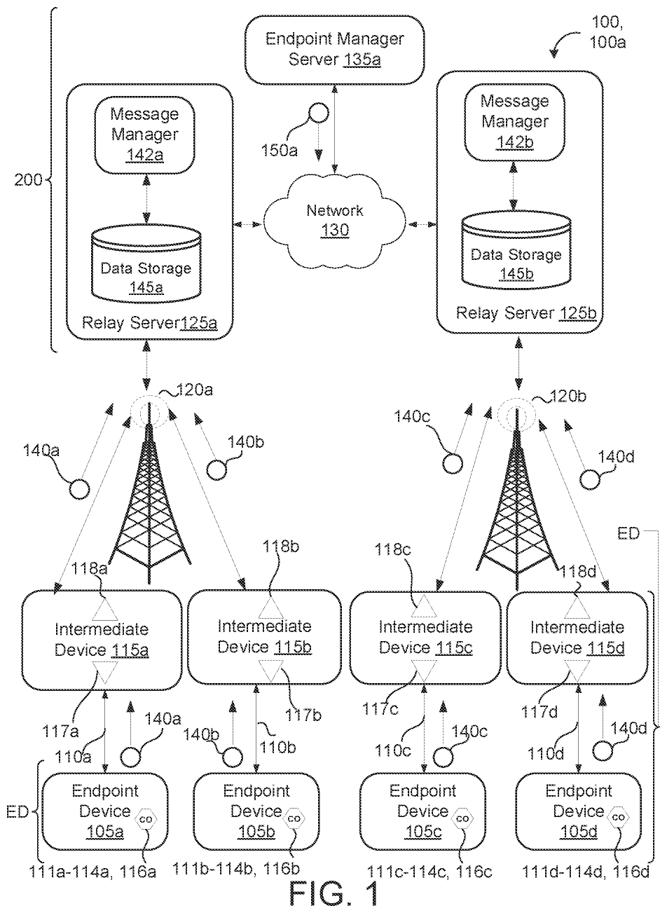

Referring to FIG. 1, in some implementations, an example network architecture 100, 100a may include one or more endpoint devices 105, 105a-d, one or more intermediate devices 115, 115a-d, one or more relay servers 125, 125a-b, and one or more endpoint manager servers 135, 135a. In some implementations, the network architecture 100a is capable of moving or transferring data (e.g., message, desired information, desired measurement data) between one or more endpoint devices 105 and various endpoint manager servers 135 by way of crowd-sourced intermediate devices 115, which can be implemented as network clients, and one or more relay servers 125. In at least one implementations, the one or more endpoint devices 105 may be referred to as edge devices (“ED”). In at least one implementation, the one or more endpoint devices 105 and the one or more intermediate devices 115 may collectively be referred to as edge devices (“EDs”). In some implementations, the network architecture 100 is capable of providing “hotspot” service to one or more of the edge devices ED directly or in-directly. In some implementations, the network architecture 100 is capable of providing “hotspot” service to one or more of the endpoint devices 105 using a short-range wireless network.

In some implementations, an endpoint device 105 includes one or more Internet of Things (IoT) devices 111. To support the operation of the IoT device 111, 111a-d, the endpoint device 105 may include a power supply 112, 112a-d, a data collection device 113, 113a-d (e.g., sensor, meter, device capable of sensing environment or person), and a network device 114, 114a-d. The power supply 112 may include a battery and/or a connection to a power grid. Additionally or alternatively, the power supply 112 may include an energy harvesting apparatus, such as a solar panel, solar cell, solar photovoltaic, electromagnetic, etc. In at least some implementations, the endpoint device 105 does not include a power supply and use ambient backscatter or other suitable techniques instead to operate the endpoint device 105. The data collection device 113 in the endpoint device 105 may include one or more sensors. The one or more sensors may be configured to detect any type of condition (e.g., environmental condition, human condition), and generate electronic data based on a detected condition. For example, the endpoint device 105 may include a smart watch with a heart rate monitor (configured with the heart rate sensor) that is configured to generate heart rate data based on heart rate conditions collected by the heart rate sensor. In at least one implementation, the endpoint device 105 does not have capability to communicate over the Internet and only includes hardware and/or software capable of communicating with nearby devices, such as a nearby intermediate device 115, using one short-range wireless protocol or a combination of short-range wireless protocols. In some implementations, the endpoint device 105 includes a data storage which is used to store the condition measurement data. In some implementations, the endpoint device 105 is configured to transmit the stored data to a device (e.g., intermediate device 115) when the endpoint device 105 is in data communication with the device.

The network device 114 of the endpoint device 105 may include any suitable hardware, software, or combination thereof that is capable to communicate with another device (e.g., intermediate device 115) via a network. In at least one implementation, the network device 114 includes a network controller 116, 116a-d configured to communicate via a short-range network, such as a network implemented with Bluetooth® protocols or any other suitable type of short-range network. In at least one implementation, the network device 114 may include a network controller 116 configured to communicate via a low-power network (e.g., a suitable network that supports transmit powers from 0.01 mW to 100 mW). In some implementations, the network controller 116 is configured to communicate via a low-power and short-range network (e.g., Bluetooth® network). Example endpoint devices 105 include, but are not limited to, industrial devices, residential appliances, commercial equipment, inventory trackers, smart watches, wearables, heart rate monitors, logistics trackers, environmental sensors, cash registers, credit card readers, point-of-sale (POS), bikes, electric scooters, electric skate boards, cars, electric cars, satellites, or any device (mobile and not mobile that includes a wireless radio interface). In accordance with some implementations of the present disclosure, the network architecture 100 includes any number of endpoint devices 105, and the endpoint devices 105 in the network architecture 100a can be any type of endpoint device 105, including any type of network-capable device. The endpoint devices 105 may be fixed or relatively stationary in the network architecture 100, such as a POS or a pollution sensing device. Additionally or alternatively, the endpoint devices 105 may be mobile, such as a smart watch, or any vehicle categories (e.g., car, truck, bike, kickboard).

As illustrated in FIG. 1, in some implementations, the one or more endpoint devices 105 may be configured to communicate with other devices (e.g., intermediate devices 115) in the network via at least one first wireless network 110, 110a-d. For example, an endpoint device 105a in FIG. 1 may be in electronic communication (e.g., data communication) with an intermediate device 115a via a first wireless network 110a. The one or more intermediate devices 115 may include any kind of device capable of communicating with the endpoint device 105 via the first wireless network 110 and with the relay server 125 via a second network 120, 120a-b. In at least one implementation, the intermediate device 115 includes two network controllers: a first network controller 117, 117a-d to communicate via the first wireless network 110 and a second network controller 118, 118a-d to communicate via the second network 120. Example intermediate devices 115 include personal computers (PC), laptops, smart phones, netbooks, e-readers, personal digital assistants (PDA), cellular phones, mobile phones, tablets, vehicles, drones, cars, trucks, wearable devices, routers, televisions, or set top boxes, etc.

As illustrated in FIG. 1, in some implementations, the first endpoint device 105a may be in electronic communication with the first intermediate device 115a via the first wireless network 110a (e.g., a short-range network with a range between 10 meters and 100 meters). Further, an endpoint device 105b may be in electronic communication with an intermediate device 115b via a first wireless network 110b. An endpoint device 105c may be in electronic communication with an intermediate device 115c via a first wireless network 110c. An endpoint device 105d may be in electronic communication with an intermediate device 115d via a first wireless network 110d.

In some implementations, the first wireless network 110 may be any network that consumes or requires a relatively low amount of power (e.g., power between 0.01 mW and 100 mW). At least some example of the first wireless networks 110 include Bluetooth® network (e.g., Bluetooth Low Energy (BLE), Bluetooth 4.0, Bluetooth 5.0, Bluetooth Long Range), NarrowBand-IoT (NB-IoT) network, Long-Term Evolution (LTE) Direct network, LTE for Machines (LTE-M) network, LTE Machine-to-Machine (LTE M2M) network, 5G network, Wireless Fidelity (Wi-Fi) network, Wi-Fi Aware network, or any low-power network and/or short-range network.

As illustrated in FIG. 1, in some implementations, the one or more endpoint devices 105 is connect to various intermediate devices 115 using different kind of first wireless networks 110. For example, the first endpoint device 105a may be in electronic communication (e.g., data communication) with the first intermediate device 115a via a first wireless network 110a implemented with the BLE, and the second endpoint device 105b may be in electronic communication with the second intermediate device 115b via a first wireless network 110b implemented with other type of the short-range wireless network.

In some implementations, the first wireless network 110 and the second network 120 are different types of networks. For example, the first wireless network 110 may be a Bluetooth® network and the second network 120 may be a cellular network, Wi-Fi, or the Internet. For example, the second network 120 may include a public network (e.g., the Internet), a private network (e.g., a local area network (LAN) or wide area network (WAN)), a wired network (e.g., Ethernet network), a wireless network (e.g., an 802.xx network or a Wi-Fi network), a cellular network (e.g., a Long Term Evolution (LTE) or LTE-Advanced network, 1G network, 2G network, 3G network, 4G network, 5G network, etc.), routers, hubs, switches, server computers, and/or a combination thereof.

In some implementations, a third network 130, that connects the relay servers 125 to the endpoint manager server 135, includes a public network (e.g., the Internet), a private network (e.g., a local area network (LAN) or wide area network (WAN), a wired network (e.g., Ethernet network), a wireless network (e.g., an 802.xx network or a Wi-Fi network), a cellular network (e.g., a Long Term Evolution (LTE) or LTE-Advanced network, 1G network, 2G network, 3G network, 4G network, 5G network, etc.), routers, hubs, switches, server computers, and/or a combination thereof. In at least one implementation, the second network 120 and the third network 130 are the same network or include at least some overlapping components. In some implementations, at least some portion of the relay servers 125, third network 130, and endpoint manager server 135 is a cloud network 200 (e.g., distributed computing network). For example, relay servers 125, third network 130, and endpoint manager server 135 can form a distributed computing network that interacts with the intermediate devices 113 and endpoint devices 105. In some implementations, the edge devices ED (e.g., intermediate device 115) are included in the cloud network 200 since edge devices ED are capable of collecting and/or processing desired data.

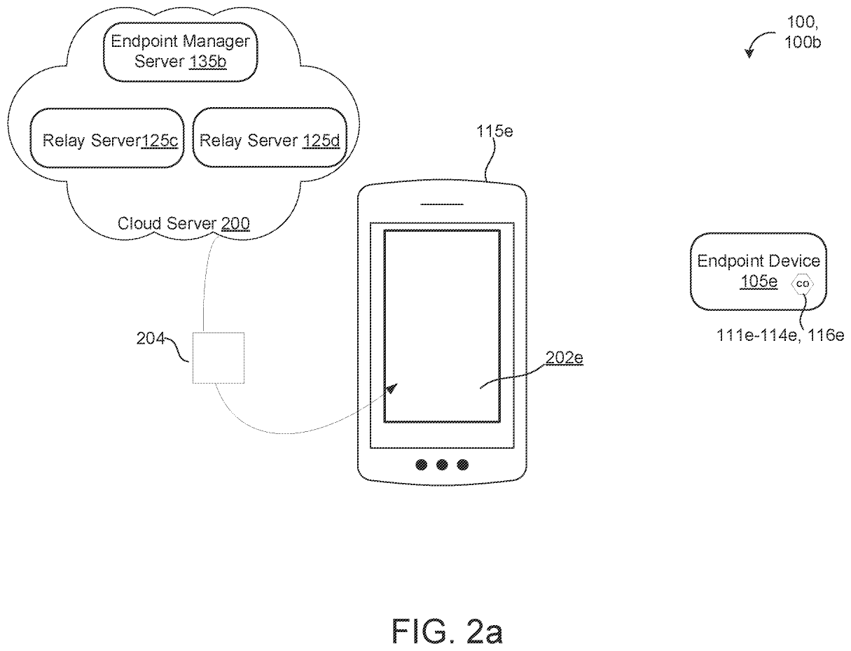

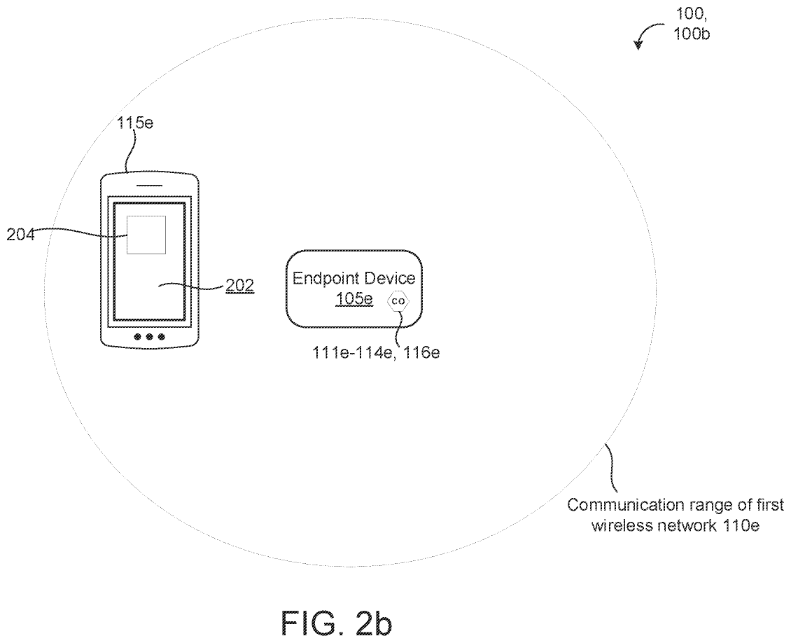

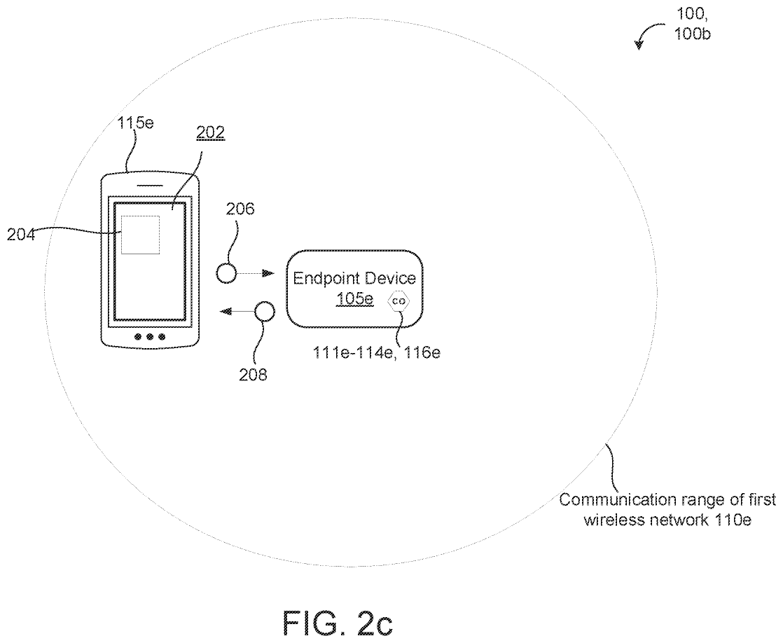

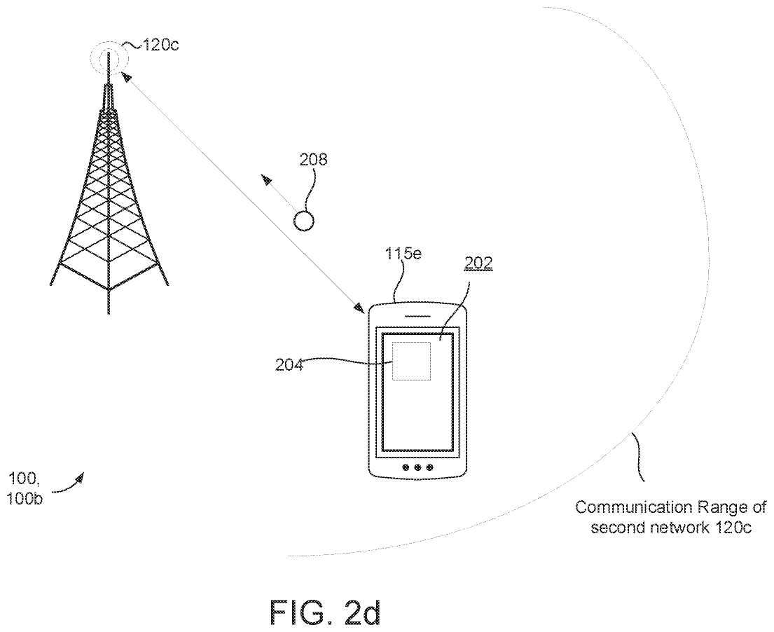

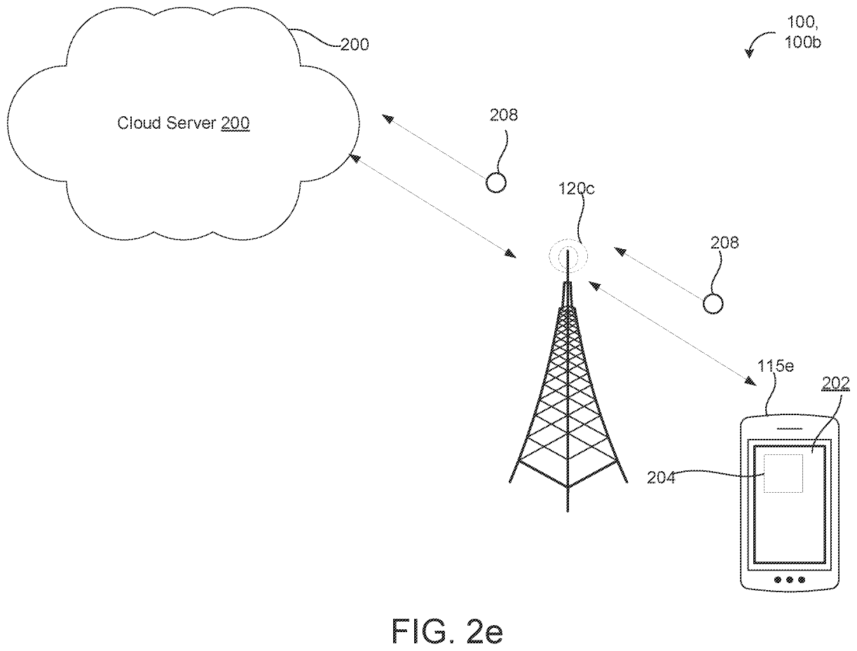

Endpoint devices 105, intermediate devices 115, or both, may be fixed, relatively stationary, or moveable. When an endpoint device 105 and an intermediate device 115 come into wireless range of each other (e.g., 10 meters), the endpoint device 105 and the intermediate device 115 may perform a handshake and/or authentication to initiate data exchange between the endpoint device 105 and the intermediate device 115 in accordance with some implementations. For example, an intermediate device 115 is configured to provide “hotspot” service to an endpoint device 105 after the authentication. In some implementations, the “hotspot” service is provided to the endpoint device 105 by executing code (e.g., program 204 shown in FIG. 2a) on a virtual environment 202 (shown in FIG. 2a) of the intermediate device 115. More detail on the code and virtual environment 202 will be discussed later in this disclosure.

In some implementations, the endpoint device 105 is configured to periodically or randomly send or transmit a beacon signal 140 or a beacon signal 140 that includes data (e.g., data that identify the transmitting endpoint device 105, data measured or received by the transmitting endpoint device 105) via the first wireless network 110. The endpoint devices 105 may include various services that may run on the endpoint devices 105. For example, a smart watch may include a clock service, a heart rate monitor service, a motion detection service, a music service, etc. Separate beacon signals 140 may be generated for each of these services or a single beacon signal may be generated to include data for some or all of the services.

In some implementations, a service can execute on-demand Bluetooth Low Energy (BLE) conversations in order to read/write information from/to the endpoint device 105 (e.g., IoT device 111 in the endpoint device 105). This works by running custom-made code (e.g., instructions or code capable of running on a virtualization environment and/or containerization environment such as bytecode and containerized program) on virtual environment 202 (e.g., virtual machine, container) operating on the edge device ED (endpoint device 105 and/or the intermediate device 115). This code (e.g., bytecode, containerized program) is also referred to as a “Smart eXchange” or “SX” in the present disclosure. In some implementations, the virtual environment 202 exposes certain opcode allowing basic networking operations such as BLE read/write, http get/post, or dtn send. Because the virtual environment 202 is Turing complete, it is possible to run any kind (or version) of BLE protocol.

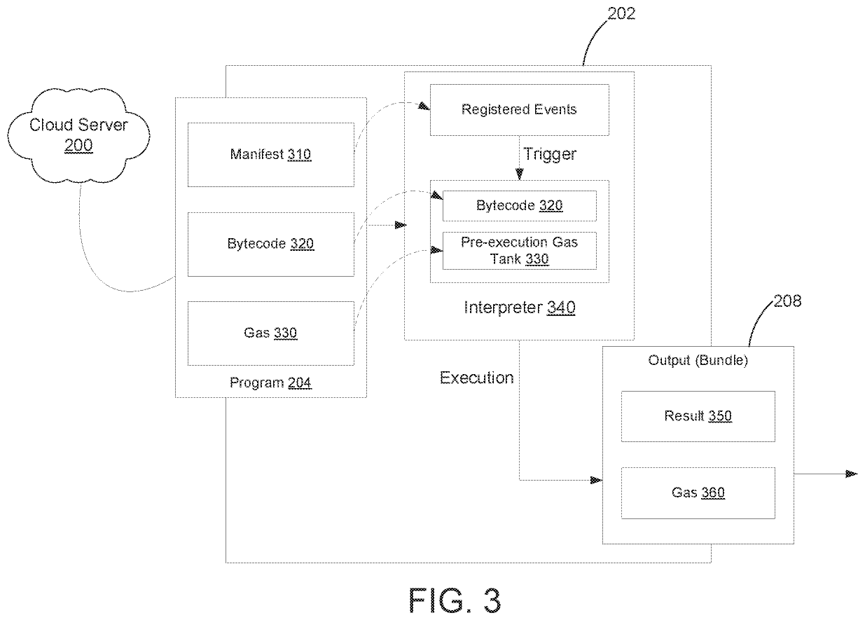

In at least one implementation, the edge devices ED (e.g., the endpoint devices 105 and/or the intermediate devices 115) include circuitry (e.g., hardware, software, or a combination thereof) that is configured to execute the code (also referred to as “program 204” in this disclosure) locally. In at least one implementation, the circuitry includes the virtual environment 202 where the code is run on. The virtual environment 202 may include an interpreter 340 (shown in FIG. 3) that can execute a program 204 (e.g., bytecode, containerized program) written in any programming language, such as in Nodle Assembly (NASM). A benefit to the virtual environment 202 residing inside an edge device ED (e.g., the endpoint devices 105 and/or the intermediate devices 115) may include an ability to selectively execute the program 204 responsive to one or more predetermined conditions (e.g., trigger event). Additional benefits of the virtual environment 202 residing inside the edge device ED may include that the program 204 can be selectively pushed from the cloud server 200 to edge devices ED—bypassing the conventional application stores (e.g., Play Store by Google, App Store by Apple). Further, the same program 204 can be pushed and installed onto different edge devices ED regardless of version and/or type of the operating system installed on the edge devices ED (e.g., version of Android, Android or IOS). However, the present disclosure does not limit that the form of the program 204. In some implementations, the program 204 is included in a conventional application that is available at the application stores. In some implementations, the program 204 is included to an operating system of the edge device ED. In some implementations, by executing the program 204, the owner of the edge device ED may receive reward (e.g., cryptocurrency) from the distributor or operator of the program (e.g., author of the program 204).

In this manner, the virtual environment 202 may use or transform a crowd-source infrastructure into an asynchronous programmable network that can tap into the resources available on each edge device ED (e.g., the endpoint devices 105 and/or the intermediate devices 115). For example, the execution of a program 204 may be triggered under certain conditions. For example, an edge device ED (e.g., intermediate device 115) may include a device that has intermittent connectivity to the Internet (e.g., smartphone) and are also mobile. More specifically, a use case may include querying data from a “hard to connect to” IoT device such as a Bluetooth device (e.g., endpoint device 105). The hard to connect to device may include a device that seldom connects (or never connects) to the Internet. In at least one implementation, a program 204 may be written and distributed, such as via system 100, to one or more intermediate devices 115 that would (only) execute if those intermediate devices 115 are in range of a target endpoint device 105 (e.g., endpoint device 105 configured with a target IoT device 111). In this condition, the program 204 may execute, which may include an interaction with the target device (e.g., endpoint device 105) to fetch a specific piece of data (e.g., desired information such as pollution data when the endpoint device 115 is equipped with a pollution sensor) and the output of that data requested (e.g., desired information) may then be moved or transmitted to the relay server 125 and/or the endpoint manager server 135 whenever the intermediate device 115 (e.g., smart phone) has connectivity (e.g., connectivity to the second network 120). In this implementation, a group of edge devices ED selected to have the program 204 installed can be considered as a distributed computing network since each of the edge devices ED with the program 204 installed is configured to gather and/or process the specific pieces of data (e.g., querying the specific data, receiving the specific data, determining that the received data includes the specific data, transmitting the specific data).

In some implementations, a program 204 is configured to cause one edge device ED (endpoint device 105 and/or intermediate device 115) to communicate (e.g., sharing, relaying, routing data or message) with another edge device ED (endpoint device 105 and/or intermediate device 115) nearby using a short-range wireless network (e.g., first wireless network 110). In a specific example, a group of edge devices ED are selected to have the program 204 installed (relay service program in this example). Based on the program 204, the edge devices ED are configured to provide data and/or message relay service. For instance, an endpoint manager server 135 (endpoint manager server 135a in this example) sends or transmits a message 150 (e.g., advertisement, announcement, information, data, firmware, program 204) to one of the edge devices ED (intermediate device 115a in this example) configured with the program 204. In some implementations, the edge device ED (intermediate device 115a), which received the message 150 from the endpoint manager server 135, relays or transmits the message 150 to other edge devices ED nearby (intermediate device 115b in this example) configured with the program 204 via the short-range wireless network (e.g., first wireless network 100). Similarly, the message 150 is relayed or propagated from the intermediate device 115b to the intermediate device 115c via the short-range wireless network (e.g., first wireless network 110) and then from the intermediate device 115c to the intermediate device 115d via the short range wireless network (e.g., first wireless network 110). In some implementations, similarly, the message 150 can be transmitted or propagated to nearby endpoint devices 105 (endpoint devices 105a-d in this example) installed with the program 204. For example, the message 150 can be relayed or transmitted between the endpoint devices 105 nearby. In other words, the message 150 from the endpoint manger server 135 can be delivered to edge devices ED configured with the program 204 in a particular area using the short-range wireless network (e.g., first wireless network 110). In some implementations, each of the intermediate devices 115 received the message 150 can relay or transmit the message 150 to endpoint devices 105 nearby via the short-range wireless network (e.g., first wireless network 110). In this manner, local, ad-hoc networks of devices can be created.

A server, for example, can push an instruction that may be received by at least one device. That device, can establish a network and can forward the instruction to any other device within range. Those devices can join the network, and can forward the instructions again to other devices within their respective range. In this manner, instructions for creating networks can be propagated. In some examples, the instruction may include a network limiter, which may be geography-based, size-based, number of joined devices-based, time-based, etc. In a geography-based limitation on a network, for example, the instruction may include an identification of a central point for the network, such a GPS location, latitude/longitude coordinates, etc. and a distance from that central point where the network is permitted. For example, a stadium can be selected as the central point, a distance from that central point, such as a boundary to substantially encompass the stadium, as well as a time in which the network may expire, such as after a sports event. For devices that receive the instruction to join the network, those devices can perform a check first to see if the criteria is met, and if so, those devices can join the network. If at least one of the criteria is not met (e.g., out of range, beyond the time limit, etc.) then the device may not join the network. The potentially joining device, for example, can check its own location (e.g., actual location, distance from the central point, etc.) to see if it is within the range. Devices that join the network, for example, can append data to instructions that are forwarded. For example, a number of devices that are joined can be data included in the instructions and a potentially joining device can check that number versus a total allowable number of devices on the network. That potentially joining device can join the network if there are still available spots for devices and may not join if there are no more available spots. As devices leave the network, other devices may join, and may even receive a notification that the network is now available to join.

In some implementations, the intermediate devices 115 and endpoint devices 105 (that are configured with the program 204) can form one mesh network using the short-range wireless network (e.g., first wireless network 110) so information (e.g., data 140, message 150) can be transmitted between devices (e.g., endpoint devices 105, intermediate devices 115) within the mesh network using the short-range wireless network (e.g., first wireless network).

In another example, the edge device ED (intermediate device 115a in this example), which receives data 208 (e.g., data collected from IoT device/endpoint device) from an endpoint device 105 (endpoint device 105a in this example) can relay or transmit the data 208 to other intermediate devices 115/endpoint devices 105 nearby similar to the message 150 above (e.g., using mesh network, using intermediate device-to-intermediate device network, using endpoint device-to-endpoint device network, using intermediate device-to-endpoint device network). This method is helpful when the intermediate device 115 (intermediate device 115a) does not have an access to a second network 120 (outside of coverage of the second network 120a in this example). Using this method, the data 208 can be relayed to the intermediate device 115d via various routes and transmitted to the endpoint server 135 via the second network 120 (second network 120b in this example). In other words, in some implementations, a “hotspot” service can be provided to the edge device ED (endpoint device 105a and intermediate device 115a in this example) using the program 204 based on the short-range wireless network (e.g., first wireless network 110). Any type of data may be sent to and via the network, including targeted advertisements that are time-based and could also be interest-based. For example, continuing the sports event example from above, an advertisement that could be more applicable to the audience in the stands at the time could be sent, such as for merchandise, or could be for a coupon to the concessions stand at the stadium.

The network can also be used to create a social network, which may be based on a proximal social graph of the devices in the network as well as based on users of those devices. Such a proximal social network that can be leveraged by any code executed on devices. With the sports event example, a proximal and temporal social network can be created for fans in the stadium. Multiple proximal social networks can also be created within a geographical range, such as one for each team that is playing at the sport event, and for any number of other interest groups. In some embodiments, the social networks are predefined. Additionally or alternatively, a social network may be created based on input received via one or more of the devices. In some embodiments, social networks created based on user input may be subject to one or more filters that may prevent certain types of social networks from being created.

In another example, data to be sent to a particular device on the local network can be addressed to the network itself with also an identifier or address of the ultimate destination device. When the data reaches any device on the network, it can then forward or route the data to the ultimate destination device, which may reach the ultimate destination device with one hop or multiple hops. In a specific example, a virtual environment 202 may be provided in a wearable device, such as smart glasses. The program 204 executed on the virtual environment 202 may use a device or sensor on the smart glasses, such as a wireless receiver or an image sensor, to collect data. A condition may include an identification of a particular item or object using the wireless receiver or image sensor. For example, the wireless receiver may receive a beacon signal 140 from a vehicle that is owned by the wearer of the smart glasses. When the condition is met, the program 204 executed on the virtual environment 202 may facilitate a vehicle operation, such as unlocking a door of the vehicle (e.g., by transmitting a command). For the image sensor, when the image sensor of the smart glasses capture a specific object (e.g., a gas station), the image sensor (e.g., edge device ED configured with the image sensor) may capture the gasoline prices and may transmit them over a network (e.g., second network 120, third network 130) to a computing device (e.g., relay server 125, endpoint manager server 135) that collects (and may cause publication of) such gasoline prices. Examples of conditions, and related actions based on those conditions are numerous and made possible by the present disclosure. Another example is provided in FIGS. 2a-d.

Referring to FIGS. 2a-e, in some implementations, an example network architecture 100, 100b includes an endpoint device 105e configured with the IoT device 111e to collect desired data (air pollution data in this example). As described above, to support the operation of the IoT device 111, the endpoint device 105 may include the data collection device 113. In the example network architecture 100, the data collection device 113e of the endpoint device 105e includes an air pollution sensor (e.g., sensor or meter that can measure at least one of carbon monoxide, lead, nitrogen oxides, ground-level ozone, or particle in the air in this example). As illustrated in FIG. 2a, the example network architecture 100 includes a cloud server 200 (e.g., endpoint manager server 135b, relay server 125c, relay server 125d) that is configured to distribute a program 204 to one or more target intermediate devices 115 (intermediate device 115e in this example) via the Internet or other suitable network (e.g., second network 120, third network 130) to execute the program 204 at the intermediate device 115e when a predetermined condition is met. In this implementation, the program 204 is configured to execute for collecting the desired data (e.g., air pollution data) from a desired endpoint device 105e when the desired endpoint device 105e is nearby.

As illustrated in FIG. 2a, in some implementations, the example network architecture 100 includes an intermediate device 115e that is configured with the virtual environment 202e (e.g., virtualization environment, containerization environment). Once the program 204 is received by the intermediate device 115e, the program 204 is ready to execute or run on the virtual environment 202e to fulfill a specific mission. For example, in this example, the specific mission of the program 204 is providing service of retrieving the air pollution date from the desired endpoint device 105e. In some implementations, the program 204 includes at least one unique identification of the desired endpoint device 105e (e.g., media access control (MAC) address associated with the desired endpoint device 105e, universally unique identifier (UUID) associated with the desired endpoint device 105e) to determine the event that triggers the execution of the program 204 (e.g., determining that the intermediate device 115e is within the communication range of the desired endpoint 105e, detecting a beacon signal from the endpoint device 115e).

Referring to FIG. 2b, in some circumstances, the intermediate device 115e is movable. While the intermediate device 115e is moving, the intermediate device 115e listens or detects the beacon signals (e.g., listening mode) from nearby endpoint devices 105 periodically or randomly. In some implementations, based on the received beacon signals 140 (e.g., beacon signal with a unique identifier of the desired endpoint device 105e), the intermediate device 115e determines whether the intermediate device 115e is within the communication range of the desired endpoint device 105e via a first network 110e. In some implementations, the intermediate device 115e forwards the beacon signals 140 to the relay servers 125c-d and/or the endpoint manager server 135b and waits for a (confirm) message 150 from the relay servers 125c-d and/or the endpoint manager server 135b. In some implementations, based on the message 150, the intermediate device 115e determines whether the intermediate device 115e is within the communication range of the desired endpoint device 105e. In some implementations, more than one intermediate devices 115 is provided with the program 204. In some implementations, more than one unique identifier of desired endpoint 105e is included in the program 204 when there is more than one target endpoint device 105. In some implementations, the endpoint device 105 is configured to transmit the beacon signals 140 upon receiving some kind of signal (e.g., beacon signal, query signal) from an intermediate device 115.

Referring to FIG. 2c, in some implementations, when the intermediate device 115e determines that the intermediate device 115e is within the communication range of the desired endpoint 105e (e.g., matching between the unique identifier in the beacon signal 140 and the unique identification in the program 204 and/or receiving the message 150), the program 204 on the intermediate device 115e is executed to transmit a request 206 to obtain the desired data (e.g., air pollution data) from the desired endpoint device 105e. In response to the request 206 from the intermediate device 115e, the desired endpoint 105e transmits the air pollution data 208 to the intermediate device 115e. In some implementations, the intermediate device 115e is configured to store the data in its storage. In some implementations, the intermediate device 115e is configured to transmit the data to the cloud server 200 when the second network 120c (e.g., WI-FI, cellular network) is available to the intermediate device 115e.

Referring to FIGS. 2d and 2e, in some implementations, the intermediate device 115e transmits the desired data to the cloud server 200, when the Internet or suitable network connection (e.g., second network 120, third network 130) is available to the intermediate device 115e.

Referring to FIG. 3, in some implementations, the virtual environment 202 is provided in an edge device ED (e.g., endpoint device 105 and/or intermediate device 115) where the program 204 can be installed to. In this example, a program 204, pushed by a cloud server 200, is installed onto a virtual environment 202 of an intermediate device 115. As discussed above, the virtual environment 202 may include an interpreter 340 that can execute a program 204 (e.g., bytecode, containerized program) written in any programming language, such as in Nodle Assembly (NASM). A benefit to the virtual environment 202 residing inside an edge device ED (e.g., the endpoint devices 105 and/or the intermediate devices 115) may include an ability to selectively execute the program 204 responsive to one or more predetermined conditions. Additional benefits of the virtual environment 202 residing inside the edge device ED may include that the program 204 can be selectively pushed from the cloud server 200 to edge device ED—bypassing the conventional application stores (e.g., Play Store by Google, App Store by Apple). Further, the same program 204 can be pushed and installed onto different edge devices ED regardless of version and/or type of the operating system installed on the edge devices ED (e.g., version of Android, Android or IOS). Also, the program 204 requires less resources (e.g., computation resource), and multiple programs 204 can be installed to one edge device ED so the edge device ED can provide various services (e.g., capturing pollution data and looking for or tracking an asset at the same time).

As shown in FIG. 3, in some implementations, a cloud server 200 is able to selectively push a program 204 to the edge device ED (intermediate device 115 in this example). In some implementations, the program 204 includes several information including manifest 310, bytecode 320, and gas 330. For example, the manifest 310 may include a condition or event (e.g., target edge device ED unique identifier which triggers the target edge device ED found event) or data related to the condition or the event. In some implementations, the manifest 310 may describe certain parameters surrounding the computation. For example, the manifest 310 may include target information (e.g., identifier of endpoint device 105). In the target information, a target is defined as one or more constraint such as a device BLE MAC address, a geographic area, an advertised service universally unique identifier (UUID). In some implementations, when a target device is found (e.g., detecting an endpoint device 105 with the matching MAC address), a BLE connection is made or established and the event “BleDeviceConnected” is fired. Accordingly, the bytecode is executed. In some implementations, the manifest 310 may include permissions—certain opcode including data such as location, BLE read or http request that are permissioned. In some implementations, in order for the virtual environment 202 to execute those opcodes, the permissions must be set in the manifest 310 which in turn must be signed by the operator (e.g., nodle operator). In some implementations, the manifest 310 may include amount of resource (e.g., memory, random access memory) needs to be allocated for the computation. In some implementations, bytecode 320 includes codes that is configured to run on the virtual environment 202. In this example, by executing the codes, the intermediate device 115 can provide various services (e.g., obtaining data from a target endpoint device 105 equipped with an IoT device, tracking a stolen item) and provide output a result 350 (e.g., data from a target endpoint device 105 such as pollution data, tracking report). In some implementations, the gas 330 indicates a maximum amount of cryptocurrency (e.g., in NODL) or reward the owner of the edge device EN will receive for execution of the bytecode 320. As discussed above, in some implementations, execution of the bytecode 320 is triggered by events that are declared on the manifest 310 (e.g., manifest file). In some implementations, prior to beginning the execution, the bytecode 320 is entirely copied to the memory of the virtual environment 202 (e.g., virtual machine memory).

In some implementations, the structure of the bytecode 320 may include header, event segment, text segment, data segment, RAM segment, stack, and memory. In some implementations, the header may be 16 bytes and may include of 4 successive uint32 value encoding offsets to the different segment in this order: eventOffset, textOffset, dataOffset, ramOffset. Those value are absolute real addresses (direct offset within the bytecode binary). In some implementations, the events segment contains pointer to the different event callback. It is encoded as a simple list of a pair of uint8 coding the eventId and uint32 coding for the callbackOffset. The callbackOffset values may be relative to the beginning of the text segment and so it starts at 0x00. In some implementations, the text segment contains the actual bytecode. Each opcode is encoded as a single uint8 except for the PUSH opcode which takes 1 to 8 immediate uint8 value as argument. All opcodes pop their operands from the top of the stack and push their result. In some implementations, data segment contains initialized data such as strings. The bytecode may use this part of the memory as read-only. In some implementations, RAM segment can be freely use by the bytecode to store any data during the execution of the program 204. Its size is set in the manifest minus the size of the bytecode itself. In some implementations, the virtual environment 202 (e.g., virtual machine) maintains a stack of int64 used to hold local variables, function call arguments or local address. In some implementations, the memory is a contiguous array of uint8 used to hold transient data while the conversation is being executed. As discussed above, the bytecode may be copied into memory before execution starts.

In some implementations, when triggered, the program 204 executes. In at least one implementation, an instruction may cost money (e.g., in NODL) and so the gas tank drops according to the execution. In some implementations, the gas tank information 360 is output by the codes. If the tank is empty, the execution cannot continue and this produces an execution error. Otherwise the execution may stop naturally. In some implementations, when the tank is empty, execution may continue but no cryptocurrency or reward may be provided to the owner of the edge device EN for execution of the bytecode 320. In some implementations, a scaled amount of cryptocurrency or reward is provided to the owner of the edge device EN for execution of the bytecode 320 and the scaled amount is based on the level of gas in the gas tank.

In some implementations, each execution that is terminated, either with an error or not, produces the emission of another bundle back to the destination. This bundle is cached locally until the edge device ED has an opportunity of transmission, which may provide a delay-tolerant network mechanism. This new bundle contains the execution output (e.g., desired data from a pollution sensing device) as well as the amount of gas left which can later be redeemed.

Referring back to FIG. 1, in some implementations, each of the intermediate devices 115 is configured to listen or detect the beacon signals 140 transmitted from surrounding endpoint devices 105. In response to receiving the beacon signals 140, the intermediate devices 115, which detected the beacon signal 140, sends or forwards the beacon signals 140 to a (corresponding and/or nearby) relay server 125 via a second network 120 in accordance with some implementations. In at least one implementation, the first wireless network 110 and the second network 120 are different networks (e.g., different network type, different coverage range). For example, the first wireless network 110 may be a Bluetooth® network or a short-range network and the second network 120 may be a cellular network, Wi-Fi, or the Internet (which may provide a wider coverage than the short-range network).

In some implementations, each of the relay servers 125 is configured to receive the beacon signals 140 from the edge devices ED (intermediate device 115 in this example) connected via the second network 120. In some implementations, each of the relay servers 125 is configured to send or forward the beacon signals 140 (e.g., beacon signal 140 received from the intermediate device 115 and/or the endpoint device 105), and/or information (e.g., desired data) related to the beacon signals 140 (e.g., unique identification in the beacon signal 140 received from the intermediate device 115 and/or the endpoint device 105), to an endpoint manager server 135 via a third network 130. In at least one implementation, the second network 120 and the third network 130 are the same network or include at least some overlapping components.

In some implementations, each of the relay servers 125 includes one or more computing devices (such as a rackmount server, a router computer, a server computer, a personal computer, a mainframe computer, a laptop computer, a tablet computer, a desktop computer, smartphone, cars, drones, a robot, any mobility device that has an operating system, etc.), data storage (e.g., hard disks, memories, databases), networks, software components, and/or hardware components.

As illustrated in FIG. 1, in some implementations, each of the relay servers 125 is configured to receive a message 150, 150a from the endpoint manager server 135. In some implementations, each of the relay servers 125 is further configured to send or forward the message 150 from the endpoint manager server 135 to the intermediate devices 115. In at least some implementations, each of the intermediate devices 115 is configured to receive the message 150 and forward the message 150 to the endpoint devices 105.

In some implementations, the endpoint manager server 135 includes one or more computing devices (such as a rackmount server, a router computer, a server computer, a personal computer, a mainframe computer, a laptop computer, a tablet computer, a desktop computer, a smartphone, a car, a drone, a robot, any mobility device that has an operating system etc.), data storage (e.g., hard disks, memories, databases), networks, software components, and/or hardware components. The endpoint manager server 135 may be associated with one or more endpoint devices 105. For example, a particular corporation, person, or manufacturer may sell an endpoint device 105 and may use an endpoint manager server 135 to communicate with and/or control the endpoint devices 105.

In some implementations, the endpoint manager server 135 is configured to send or transmit messages 150 associated with a particular endpoint device 105, or a set of endpoint devices 105. For example, the endpoint manager server 135 is configured to send or transmit updates (e.g., firmware, software, program 204 as discussed above) to the particular endpoint device 105, or the set of endpoint devices 105. The endpoint manager server 135 may send other communications to an endpoint device 105, such as a response to a request from a beacon signal 140 generated by the particular endpoint device 105.

In some implementations, each of the relay servers 125 includes a message manager 142, 142a-b. The message manager 142 may be implemented using hardware including a processor, a microprocessor (e.g., to perform or control performance of one or more operations), a field-programmable gate array (FPGA), or an application-specific integrated circuit (ASIC). In some other instances, the message manager 142 may be implemented using a combination of hardware and software. Implementation in software may include rapid activation and deactivation of one or more transistors or transistor elements such as may be included in hardware of a computing system (e.g., the relay server 135). Additionally, software defined instructions may operate on information within transistor elements. Implementation of software instructions may at least temporarily reconfigure electronic pathways and transform computing hardware.

In some implementations, each of the relay servers 125 includes a data storage 145, 145a-b. The data storage 145 may include any memory or data storage. In some implementations, the data storage 145 includes computer-readable storage media for carrying or having computer-executable instructions or data structures stored thereon. The computer-readable storage media may include any available media that may be accessed by a general-purpose or special-purpose computer, such as a processor. For example, the data storage 145 may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may be included in the data storage 145.

As illustrated in FIG. 1, in some implementations, the data storage 145 is part of the relay server 125. In some implementations, the data storage 145 is separate from the relay server 125 and may access the data storage 145 via a suitable network. In at least one implementations, the data storage 145 includes multiple data storages.

The data storage 145 may include data pertaining to the endpoint devices 105, intermediate devices 115, and endpoint manager servers 135 and relationships between the endpoint devices 105, intermediate devices 115, and endpoint manager servers 135. For example, the data storage 145 may include a table or list of endpoint devices 105 that are associated with a particular endpoint manager server 135. The data storage 145 may include data pertaining to beacon signals 140 received from endpoint devices 105, such as a timestamp of the receipt of the beacon signal 140, a timestamp associated with the creation of the beacon signal 140, a geo-location associated with the beacon signal 140 and/or the endpoint device 105 that created or transmitted the beacon signal 140, sensor data associated with the endpoint device 105, routing information for how and/or where to send data between endpoint manager servers 135 and endpoint devices 105, connection strengths between intermediate devices 105 and endpoint devices, proximity of an endpoint device 105 to an intermediate device 115, type of first wireless network 110 that connects an intermediate device 115 and an endpoint device 105, a cost of a connection between an intermediate device 115 and an endpoint device 105, a current battery level of the intermediate device, a type of intermediate device 115, etc.

In some implementations, the message manager 142 processes communications between the endpoint devices 105, the intermediate devices 115, and the endpoint manager server(s) 135. In an example, the message manager 142 may receive a beacon signal 140 from the intermediate device 115 via the second network 120. The beacon signal 140 may have been sent to the intermediate device 115 via the first wireless network 110 by endpoint device 105. In some implementations, the beacon signal 140 contains characteristics about the endpoint device 105, including an identifier of the endpoint device 105 (e.g., MAC address, unique identification), a geographical location of the endpoint device 105, and advertisements of the UUIDs of the services it supports, etc. The message manager 142 may identify the characteristic of the beacon signal 140, such as by analyzing the beacon signal 140 to identify information pertaining to the beacon signal 140. The message manager 142 may access the data storage 145 to identify, based on the characteristic of the beacon signal 140, an endpoint manager server 135 that is associated with the beacon signal 140. For example, the identifier of the endpoint device 105 may be associated with a particular manufacturer that operations a particular endpoint manager server 135. The message manager 142 may identify this particular endpoint manager server 135 in the data storage 145 and an address and/or path to send the beacon signal 140 in order to reach the endpoint manager server 135. In at least some implementations, the message manager 142 may send the beacon signal 140, or a beacon message to the endpoint manager server 135 via the third network 130. The beacon message may include the beacon signal 140, may not include the beacon signal 140, or may include information pertaining to the beacon signal 140.

In at least one implementation, a beacon signal 140 includes data from multiple services associated with the endpoint device 105. Additionally or alternatively, multiple beacon signals 140 from a single endpoint device 105 may be generated and broadcast via the first wireless network 110. Each of these multiple beacon signals 140, for example, may be associated with a different service associated with the endpoint device 105. The message manager 142 may identify the services, and based on information for the service, identify an appropriate endpoint manager server 135 that should receive a beacon signal 140.

In some implementations, the endpoint manager server 135 is configured to receive the beacon signal 140 (e.g., message) from the relay server 125. The endpoint manager server 135 may store the beacon signal 140, process the beacon signal 140, generate a report based on the beacon signal 140, may generate a notification or response based on the beacon signal 140, or any other action. For example, the endpoint manager server 135 may generate a response message 150 pertaining to the beacon signal 140. The response message 150 may include a message 150 intended for one or more of the relay server 125, an intermediate device 115, the endpoint device 105 that generated the beacon signal 140, or another endpoint device 105 that did not generate the beacon signal 140. The endpoint manager server 135 may send the response message to the same relay server 125 that sent the beacon signals 140 to the endpoint manager server 135, or to a different relay server 125 that did not send the beacon message to the endpoint manager server 135.

The relay server 125 may receive, from the endpoint manager server 135, the response message 150 pertaining to the beacon signal 140. The relay server 125 may process the response message 150, such as by performing operations at the relay server 125, sending data to another device (e.g., a user device), sending data to an endpoint device 105, etc.

The network architecture 100 may be used to exchange data between any devices capable of network-based communication in a manner that is different than conventional communication over the Internet.

In an example, the network architecture 100 may leverage existing smartphone infrastructure to create delay-tolerant connectivity. The network architecture 100 can move data to the cloud in an initially delay tolerant fashion, which may be useful for many types of IoT communications such as firmware updates, status updates, log-file storage, and micropayments. The intermediate device 115 may include software (e.g., application, program 204 as discussed above) that runs on smartphones to periodically scan for other devices (e.g., the endpoint devices 105) like industrial devices, smartwatches, wearables, logistics trackers, and environmental sensors. These endpoint devices 105 may connect with the software client running on the smartphones to create massive, area wide networks for moving data to and within the cloud.

Further, it has been estimated that 95% of the human population is covered by some sort of cellular service. The network architecture 100 can be deployed anywhere in the world and enables regions of lower connectivity to increase their connectivity. Moreover, the network architecture 100 can provide coverage beyond the reach of conventional cellular networks by using software that runs on Bluetooth®-enabled smartphones, for example. Users may travel to areas of limited or no cellular connectivity, but still may receive beacon signals 140 from endpoint devices 105 via the wireless network 110. Using the network architecture 100, telco operators, for example, can now easily deploy a software update to their user devices to begin communicating with endpoint devices 105 as described herein to provide higher latency IoT connectivity to even the remotest regions of the world.

In a specific example, the network architecture 100 can be used for asset tracking and management. For example, the network architecture 100 can be used to find lost items that are configured as an endpoint device 105, such as a skateboard with a wireless radio chipset, an attached tracking beacon, a laptop, etc. A user, for example, may indicate that the item is lost, such as by using a mobile application or website to indicate, to the endpoint manager server 135 or to the relay server 125, that the item is lost. In a first example, the endpoint manager server 135 may send a message 150 to one or more relay servers 125 to watch for the lost item. The relay servers 125 may add an identifier of the lost item to a lost item watch list. As intermediate devices 115 move to different geographic locations, they can execute program 204 (e.g., asset tracking program), such as using virtual machines, to watch for beacon signals 140. In this example, the intermediate devices 115 can receive beacon signals 140 from different endpoint devices 105. The intermediate devices 115 then forward the beacon signals 140 to the relay servers 125. When a relay server 125 receive a beacon signal 140, the relay server 125 can analyze the beacon signal to determine if the beacon signal 140 originated at an endpoint device 105 that is on the watch list. When the relay server 125 identifies a beacon signal that originated at an endpoint device 105 that is on the watch list, the relay server 125 can notify the endpoint manager server 135 that the lost item has been found. In at least some implementations, the relay server 125 may send the notification that the lost item has been found as a push notification or as a pull notification (i.e., in response to a request from the endpoint manager server 135). In at least some implementations, the relay server 125 may send the notification that the lost item has been found to the user device that was used by the user to indicate that the item was lost.

Modifications, additions, or omissions may be made to the network architecture 100 without departing from the scope of the present disclosure. The present disclosure more generally applies to the network architecture 100 including one or more endpoint devices 105, one or more wireless networks, one or more intermediate devices 115, one or more second networks 120, one or more relay servers 125, one or more third networks 130, and one or more endpoint manager servers 135 or any combination thereof.

Moreover, the separation of various components in the implementations described herein is not meant to indicate that the separation occurs in all implementations. In addition, it may be understood with the benefit of this disclosure that the described components may be integrated together in a single component or separated into multiple components.

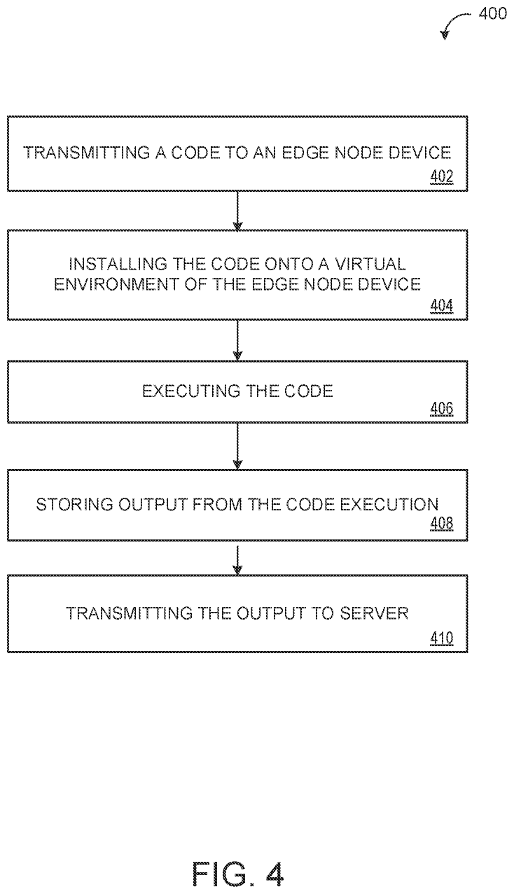

FIG. 4 is a flowchart 400 of an example arrangement of operations for a method of delay tolerance communication. The method 400 may be performed by processing logic that may include hardware (circuitry, dedicated logic, etc.), software (such as is run on a general purpose computer system or a dedicated machine), or a combination of both, which processing logic may be included in any computer system or device. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method, at operation 402, includes transmitting a code to an edge node device EN (e.g., intermediate device 115 and/or endpoint device 105) from a server (e.g., cloud server 200). As discussed above, the code (also referred to as program 204 in this disclosure) may be instructions or code capable of running on a virtualization environment and/or containerization environment such as bytecode and containerized program.

At operation 404, the method 400 includes, installing or inserting the code (i.e., program 204) onto a virtual environment 202 of the edge device ED. As discussed above, in some implementations, the virtual environment 202 may be a virtualization environment (e.g., virtual machine). In some implementations, the virtual environment 202 may be a containerization environment.

At operation 406, the method 400 includes, executing the code. As discussed above, in some implementations, the code (i.e., program 204) is configured to execute based on a trigger event to provide various services. For example, the code is trigger to run when it is determined that the edge device ED is nearby a target endpoint device 105 (equipped with a target IoT device 111) in order to obtain desired data from the IoT device 111 via the first wireless network 110.

At operation 408, the method 400 includes, storing output from the code execution. In some implementations, the stored output can be the desired data from the IoT device 111 such as pollution data. In some implementations, when the edge device ED keeps the output until the edge device ED can transmit the output to the server via the second network 120.

At operation 408, the method 400 includes, in some implementations, transmitting the output to the server (e.g. cloud server) via the second network 120 when the second network 120 is available to the edge device ED.

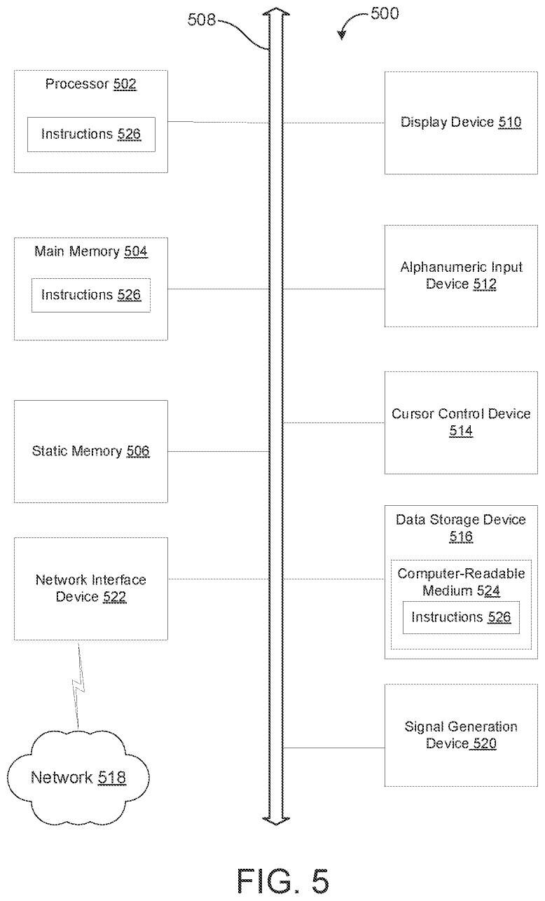

FIG. 5 is a schematic view illustrating a machine in the example form of a computing device 500 within which a set of instructions, for causing the machine to perform any one or more of the methods discussed herein, may be executed. The computing device 500 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 500 includes a processing device (e.g., a processor) 502, a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 516, which communicate with each other via a bus 508.

Processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also include one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In at least one implementation, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over a network 518 via the network interface device 522.

While the computer-readable storage medium 526 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used herein and especially in the appended claims (e.g., bodies of the appended claims) are generally intended as “open” terms (e.g., the term “including” may be interpreted as “including, but not limited to,” the term “having” may be interpreted as “having at least,” the term “includes” may be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases may not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” may be interpreted to mean “at least one” or “one or more”); the same holds true for the use of definite articles used to introduce claim recitations.

In addition, even if a specific number of an introduced claim recitation is explicitly recited, those skilled in the art will recognize that such recitation may be interpreted to mean at least the recited number (e.g., the bare recitation of “two recitations,” without other modifiers, means at least two recitations, or two or more recitations). Further, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, may be understood to contemplate the possibilities of including one of the terms, either of the terms, or both terms. For example, the phrase “A or B” may be understood to include the possibilities of “A” or “B” or “A and B.”

Implementations described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some implementations, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although implementations of the present disclosure have been described in detail, it may be understood that the various changes, substitutions, and alterations may be made hereto without departing from the spirit and scope of the present disclosure.

What is claimed is:

1. A method for communication, the method comprising:
transmitting a code to a first device via a first network, the code configured to execute on a virtual environment associated with the first device,
wherein when executed on the virtual environment, the code causes the first device to communicate with a second device via a second network,
wherein the first network is based on a first network protocol and the second network is based on a second network protocol different from the first network protocol.

2. The method of claim 1, wherein the communication includes requesting data from the second device via the second network, the data generated by an Internet of Things (IoT) device associated with the second device.

3. The method of claim 1, wherein the communication includes receiving data from the second device via the second network, the data generated by an Internet of Things (IoT) device associated with the second device.

4. The method of claim 1, wherein the virtual environment is a containerization environment.

5. The method of claim 1, wherein the virtual environment is a virtualization environment.

6. The method of claim 1, wherein the code is a containerized program.

7. The method of claim 1, wherein the code is an instruction capable of executing on a virtual machine.

8. The method of claim 1, wherein the first network includes a cellular network.

9. The method of claim 1, wherein the second network includes a short-range wireless network.

10. The method of claim 1, wherein the communication includes providing hotspot service to the second device via the second network.

11. A network system for communication, the network system comprising:
data processing hardware; and
memory hardware in communication with the data processing hardware, the memory hardware storing instructions that when executed on the data processing hardware cause the data processing hardware to perform operations comprising:
transmitting a code to a first device via a first network, the code configured to execute on a virtual environment associated with the first device,
wherein when executed on the virtual environment, the code causes the first device to communicate with a second device via a second network,
wherein the first network is based on a first network protocol and the second network is based on a second network protocol different from the first network protocol.

12. The network system of claim 11, wherein the communication includes requesting data from the second device via the second network, the data generated by an Internet of Things (IoT) device associated with the second device.

13. The network system of claim 11, wherein the communication includes receiving data from the second device via the second network, the data generated by an Internet of Things (IoT) device associated with the second device.

14. The network system of claim 11, wherein the virtual environment is a containerization environment.

15. The network system of claim 11, wherein the virtual environment is a virtualization environment.

16. The network system of claim 11, wherein the code is a containerized program.

17. The network system of claim 11, wherein the code is an instruction capable of executing on a virtual machine.

18. The network system of claim 11, wherein the first device and the second device are configured to form a distributed compute network to execute one or more distributed operations.

19. The network system of claim 11, wherein the second network includes a short-range wireless network.

20. The network system of claim 19, wherein the second network includes a proximal social network.
